(19) United States
(12) Patent Application Publication
(10) Pub. No.: US 2012/0224522 A1
(43) Pub. Date: Sep. 6, 2012

(54) METHOD AND APPARATUS FOR MANAGING MULTICAST SERVICE

(75) Inventors: Eunkyung KIM, Daejeon (KR); Sung Kyung Kim, Daejeon (KR); Sung Cheol Chang, Daejeon (KR); Hyun Lee, Daejeon (KR); Chul Sik Yoon, Daejeon (KR); Won-Ik Kim, Daejeon (KR); Mi-Young Yun, Daejeon (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/411,508

(22) Filed: Mar. 2, 2012

(30) Foreign Application Priority Data
Mar. 4, 2011 (KR) 10-2011-0019666
Jul. 11, 2011 (KR) 10-2011-0068535
Jul. 11, 2011 (KR) 10-2011-0068541
Oct. 31, 2011 (KR) 10-2011-0112476
Oct. 31, 2011 (KR) 10-2011-0112478
Nov. 3, 2011 (KR) 10-2011-0113913
Nov. 3, 2011 (KR) 10-2011-0113914
Mar. 2, 2012 (KR) 10-2012-0021970

(51) Int. Cl. H04W 4/06

(52) U.S. Cl. 370/312

(57) ABSTRACT

In a method of managing a multicast service, a mobile station receives a message including multicast service flow update information from a base station that belongs to a multicast group zone including a base station set having at least one base station. The mobile station updates a parameter associated with a multicast service flow of the multicast service based on the multicast service flow update information. The multicast service flow update information includes a new multicast group zone ID, current multicast service identification information, and new multicast service identification information mapped to the current multicast service identification information.

### CROSS-REFERENCE TO RELATED APPLICATION

This application claims priority to and the benefit of Korean Patent Application Nos. 10-2011-0019666, 10-2011-0068535, 10-2011-0068541, 10-2011-0112476, 10-2011-0112478, 10-2011-0113913, 10-2011-0113914, and 10-2012-0021970 filed in the Korean Intellectual Property Office on Mar. 4, 2011, Jul. 11, 2011, Jul. 11, 2011, Oct. 31, 2011, Oct. 31, 2011, Nov. 3, 2011, Nov. 3, 2011, and Mar. 2, 2012, respectively, the entire contents of which are incorporated herein by reference.

### BACKGROUND OF THE INVENTION

(a) Field of the Invention

The present invention generally relates a multicast service managing method and apparatus.

(b) Description of the Related Art

A multicast service is used to a group communication where users join in a conversation. In the group communication, the same downlink traffic is simultaneously transmitted to all the users in a group for performing the group communication. Therefore, the users joining the group communication use a multicast connection to transmit data of the group communication.

A broadcast service such as a multicast broadcast service (MBS) is only defined as a conventional multicast service. Accordingly, since a conventional multicast service managing method cannot be applicable to the multicast service for the group communication, a new multicast service managing method is required. Particularly, because the group communication should be seamlessly supported when the user crosses the boundary, the multicast service managing method for updating the multicast service is required when the user crosses the boundary.

### SUMMARY OF THE INVENTION

Embodiments of the present invention provide a multicast service managing method and apparatus for updating a multicast service.

According to an embodiment of the present invention, a method of managing a multicast service is provided by a mobile station. The method may include receiving the multicast service, receiving a message including multicast service flow update information from a base station that belongs to a multicast group zone including a base station set having at least one base station, and updating a parameter associated with a multicast service flow of the multicast service based on the multicast service flow update information. The multicast service flow update information may include a new multicast group zone identifier (ID), current multicast service identification information, and new multicast service identification information mapped to the current multicast service identification information.

The current multicast service identification information may include a multicast group ID that is used for identifying the multicast service flow in a current multicast group zone. The new multicast service identification information may include a multicast group ID that is used for identifying the multicast service flow in a new multicast group zone.

The current multicast service identification information may include a multicast group ID and a flow ID (FID) that are used for identifying the multicast service flow in a current multicast group zone. The new multicast service identification information may include a multicast group ID and a flow ID (FID) that are used for identifying the multicast service flow in a new multicast group zone.

The message may include a neighbor advertisement (NBR-ADV) message that is periodically broadcast by the base station.

The method may further include transmitting a ranging request (RNG-REQ) message to a base station, in a connected state. In this case, the message may include a ranging response (RNG-RSP) message that is transmitted in response to the RNG-REQ message.

The method may further include transmitting an RNG-REQ message to the base station, in an idle state. In this case, the message may include an RNG-RSP message that is transmitted in response to the RNG-REQ message.

The method may further include receiving a broadcast message including a multicast group zone ID to which the base station belongs.

According to another embodiment of the present invention, a method of managing a multicast service is provided by a base station that belongs to a multicast group zone including a base station set having at least one base station. The method includes generating multicast service flow update information for a multicast service flow of the multicast service provided to a mobile station, and transmitting a message including the multicast service flow update information to the mobile station. The multicast service flow update information includes a new multicast group zone ID, current multicast service identification information, and new multicast service identification information.

The current multicast service identification information may include a multicast group ID that is used for identifying the multicast service flow in a current multicast group zone. The new multicast service identification information may include a multicast group ID that is used for identifying the multicast service flow in a new multicast group zone.

The current multicast service identification information may include a multicast group ID and an FID that are used for identifying the multicast service flow in a current multicast group zone. The new multicast service identification information may include a multicast group ID and an FID that are used for identifying the multicast service flow in a new multicast group zone.

The message may include an NBR-ADV message that is periodically broadcast by the base station.

The method may further include receiving an RNG-REQ message from the mobile station when the mobile station is in a connected state. In this case, the message may include an RNG-RSP message that is transmitted in response to the RNG-REQ message.

The method may further include receiving an RNG-REQ message from the mobile station when the mobile station is in an idle state. In this case, the message may include an RNG-RSP message that is transmitted in response to the RNG-REQ message.

The method may further include receiving a broadcast message including a multicast group zone ID to which the base station belongs.

According to yet another embodiment of the present invention, an apparatus for managing a multicast service is provided. The apparatus includes a transceiver and a controller. The transceiver receives the multicast service, and receives a message including multicast service flow update information from a base station that belongs to a multicast group zone including a base station set having at least one base station. The controller updates a parameter associated with a multicast service flow of the multicast service based on the multicast service flow update information. The multicast service flow update information includes a new multicast group zone ID, current multicast service identification information, and new multicast service identification information mapped to the current multicast service identification information.

The current multicast service identification information may include a multicast group ID that is used for identifying the multicast service flow in a current multicast group zone. The new multicast service identification information may include a multicast group ID that is used for identifying the multicast service flow in a new multicast group zone.

The current multicast service identification information may include a multicast group ID and an FID that are used for identifying the multicast service flow in a current multicast group zone. The new multicast service identification information may include a multicast group ID and an FID that are used for identifying the multicast service flow in a new multicast group zone.

According to yet another embodiment of the present invention, an apparatus for managing a multicast service is provided by a base station that belongs to a multicast group zone including a base station set having at least one base station. The apparatus includes a transceiver and a controller. The controller generates multicast service flow update information for a multicast service flow of the multicast service provided to a mobile station. The transceiver transmits a message including the multicast service flow update information to the mobile station. The multicast service flow update information includes a new multicast group zone ID, current multicast service identification information, and new multicast service identification information.

The current multicast service identification information may include a multicast group ID that is used for identifying the multicast service flow in a current multicast group zone. The new multicast service identification information may include a multicast group ID that is used for identifying the multicast service flow in a new multicast group zone.

The current multicast service identification information may include a multicast group ID and an FID that are used for identifying the multicast service flow in a current multicast group zone. The new multicast service identification information may include a multicast group ID and an FID that are used for identifying the multicast service flow in a new multicast group zone.

### BRIEF DESCRIPTION OF THE DRAWINGS

FIG. 1 to FIG. 3 each show a multicast communication system according to an embodiment of the present invention.

FIG. 4 shows a multicast connection establishment method according to an embodiment of the present invention.

FIG. 5 and FIG. 6 each are a flowchart showing a multicast service managing method according to an embodiment of the present invention.

FIG. 7 shows a multicast resource allocation method according to an embodiment of the present invention.

FIG. 8 and FIG. 9 each are a block diagram of a multicast service managing apparatus according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “mobile station (MS)” may designate a terminal, a mobile terminal (MT), an advanced mobile station (AMS), a high reliability mobile station (HR-MS), a subscriber station (SS), a portable subscriber station (PSS), an access terminal (AT), a user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, a relay station (RS) performing base station function, a high reliability relay station (HR-RS) performing the base station function and so on, or may include all or some functions thereof.

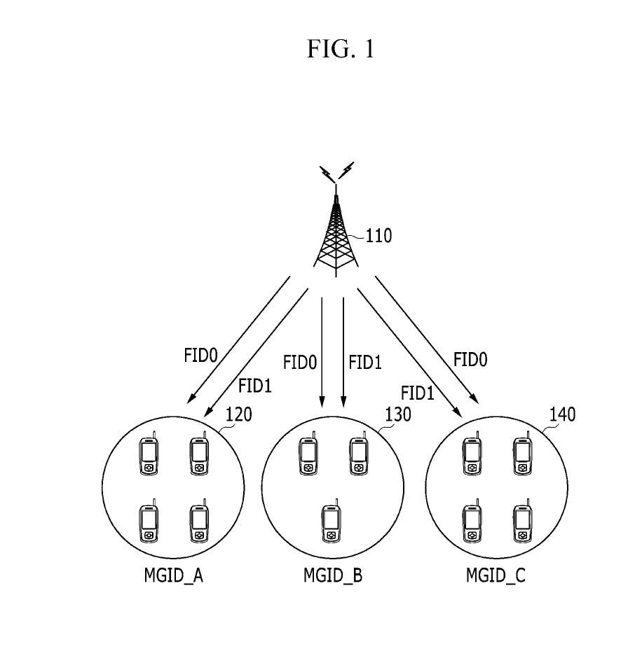

FIG. 1 shows a multicast communication system according to an embodiment of the present invention.

Referring to FIG. 1, a base station 110 uses a multicast group identifier (ID) allocated to a multicast group 120, to provide the multicast group 120 including a plurality of mobile stations with a multicast communication. The multicast group ID is uniquely allocated within the base station 110 and has a finite size. The multicast group ID is used as an ID for notifying the multicast group of the allocated resource. Other multicast groups 120, 130, and 140 have different multicast group ID MGID_A, MGID_B, and MGID_C.

The base station 110 uses a flow identifier (FID) for identifying a connection besides the multicast group ID. The base station 110 allocates the FID in each multicast group ID, thereby uniquely identifying the connection, i.e., a service flow within the multicast group. Since the FID is an ID for identifying a signal or traffic connection within the multicast group, a particular connection of the multicast group can be identified a combination of the multicast group ID and FID in the base station 110. That is, the base station 110 uses the multicast group ID and the FID to provide the multicast group 120 with a multicast service. The same FID (FID0 or FID1) may be used in the other multicast groups 120, 130, and 140.

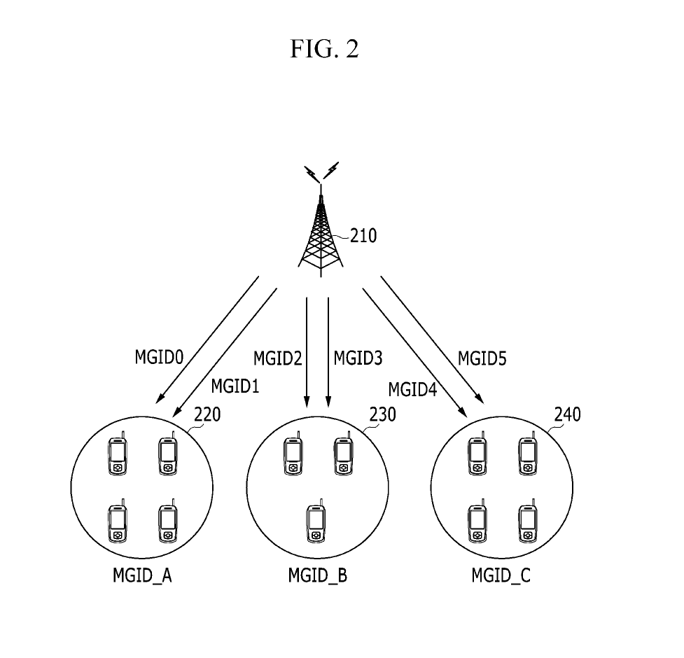

FIG. 2 shows a multicast communication system another embodiment of the present invention.

Referring to FIG. 2, a base station 210 uses a multicast group ID to provide a multicast group 220 including a plurality of mobile stations with the multicast service. The multicast group ID is uniquely allocated for identifying a connection, i.e., a service flow of the multicast group, and has a finite size. This multicast group ID may have a greater size than the multicast group ID described in FIG. 1, in order to identify the service flow as well as the multicast group. For example, the multicast group ID of FIG. 1 may have 12 bits, and the multicast group ID of FIG. 2 may have 16 bits. Hereinafter, the multicast group ID of FIG. 1 is referred to as a multicast group ID1, and the multicast group ID of FIG. 2 is referred to as a multicast group ID2.

Other multicast group ID2s (MGID0, MGID1, MGID2, MGID3, MGID4, and MGID5) are used in different multicast groups 220, 230, and 240. A multicast resource allocated to the multicast service can be notified to the multicast group through the multicast group ID.

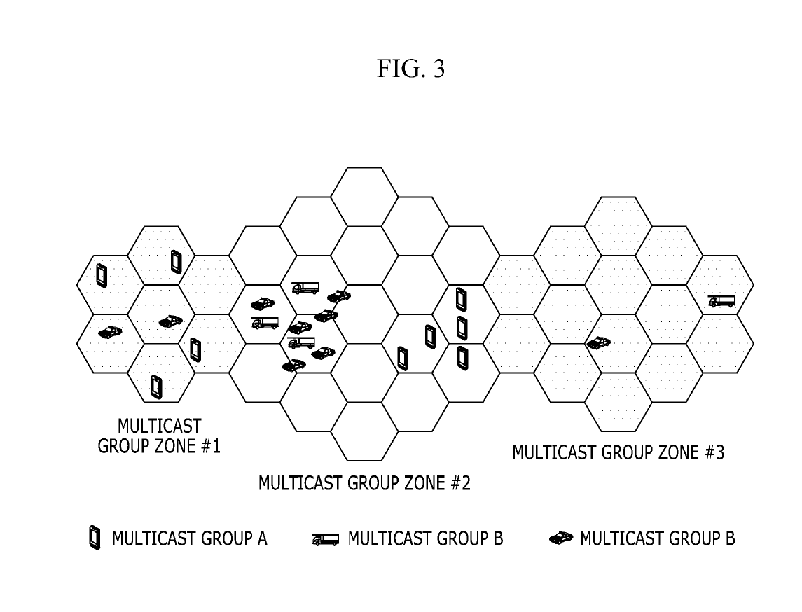

FIG. 3 shows a multicast communication system according to yet another embodiment of the present invention.

Referring to FIG. 3, a multicast group zone is defined as a base station set including at least one base station in a group communication system according to an embodiment of the present invention. A unique multicast group zone ID is allocated to the multicast group zone. A multicast group ID1 having a unique value is allocated to a multicast group within the multicast group zone, and a multicast service can be identified using an FID within the multicast group. That is, the multicast service that is provided within the multicast group zone can be identified using the multicast group ID1 and FID. Alternatively, a multicast group ID2 having a unique value is allocated to a multicast group within the multicast group zone, and a multicast service that is provided within the multicast group zone can be identified using the multicast group ID2.

In the multicast group zone, a set of base stations uses the same multicast group ID1 and FID or the same multicast group ID2 for transmitting data of a certain service flow. Accordingly, if a mobile station has already registered with a base station for a multicast service, the mobile station can be seamlessly receive the multicast service without reregistering with other base station even if the mobile station moves to the other base station within the same multicast group zone. If the mobile station moves from a base station to another base station, those base stations provide the same multicast service but belong to different multicast group zone, the mobile station can seamlessly receive the multicast service by updating a service flow parameter.

If only one base station belongs to a multicast group zone, the single base station uses a multicast group ID2 for providing a multicast service, independently from other base stations.

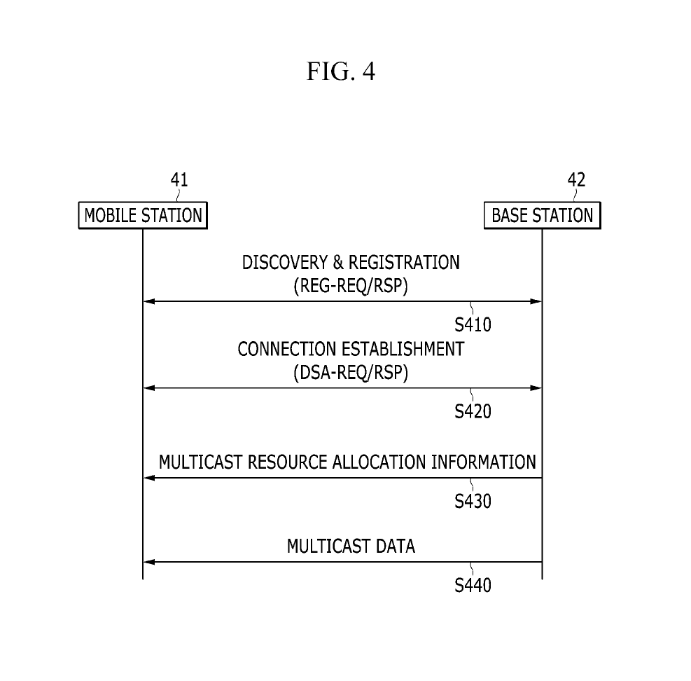

FIG. 4 shows a multicast connection establishment method according to an embodiment of the present invention.

Referring to FIG. 4, a mobile station 41 transmits a registration request (REG-REQ) message and a base station 42 transmits a registration response (REG-RSP) message to the mobile station 41 in response to the REG-REQ message (S410). To discover a multicast service, the mobile station 41 informs the base station 42 of support of multicast transmission by the REG-REQ message base station 42 and the base station 42 register the mobile station 41 by the REG-RSP message.

When the mobile station 41 registers to receive the multicast service, either the mobile station 41 or the base station 42 initiates a dynamic service addition (DSA) procedure for a multicast connection service (S420). The one node of the mobile station 41 and the base station 42 transmits a DSA-REQ message to the other node and receives a DSA-RSP message from the other node such that the multicast connection is established.

The DSA-REQ and DSA-RSP messages include a multicast parameter associated with the multicast service. The multicast parameter includes a multicast group ID1 or a multicast group ID2 of a multicast group to which a service flow is added. When the multicast parameter includes the multicast group ID1, the multicast parameter may further include a FID associated with the multicast group ID1.

Further, when a multicast group zone is supported, the multicast parameter may further include a multicast group zone ID where the service flow is valid. The mobile station 41 can add the service flow for starting a multicast service by the multicast parameter. Alternatively, the base station may periodically broadcast a multicast group zone ID through a broadcast message. If the multicast group zones are not locally overlapped with each other and are identified from each other (that is, a base station belongs to only one multicast group zone or the multicast group zone is not defined), the multicast parameter of the DSA-REQ or DSA-RSP message may not include multicast group zone ID.

The mobile station 41 and the base station 42 may not exchange a multicast service capability in the REQ-REQ/RSP exchange procedure (S410) but exchange the multicast service capability in the DSA-REQ/RSP exchange procedure (S420).

As such, after establishing the service flow, the mobile station 41 receives a downlink control channel including multicast resource allocation information from the base station 42 (S430), and receives multicast data from the base station 42 through the allocated resource (S440).

When a change of the service flow is required in the multicast service, the mobile station 41 and the base station 42 may perform a dynamic service change (DSC) procedure. That is, any one node of the mobile station 41 and the base station 42 transmits a DSC-REQ message, and the other node responds as a DSC-RSP message. In this case, the DSC-REQ message and the DSC-RSP message include a multicast parameter. The multicast parameter may include a current multicast group ID2 and a new multicast group ID2, or current multicast group ID1 and FID and new multicast group ID1 and FID. The multicast parameter may further include a new multicast group zone ID. When the multicast service is terminated, the mobile station 41 and the base station 42 may perform a dynamic service delete (DSD) procedure to delete the service flow. In this case, the multicast service of the multicast group may be terminated using the multicast group ID1 or the multicast group ID2 in the DSD procedure. The base station may terminate the multicast service using the multicast group zone ID in the DSD procedure. Any one node of the mobile station 41 and the base station 42 transmits a DSD-REQ message, and the other node responds as a DSD-RSP message.

As described above, according to an embodiment of the present invention, a mobile station and a base station can identify a supported multicast service through an exchange of a multicast service capability, and add, change or delete a service flow for the multicast service through a DSx (DSA, DSC, or DSD) procedure.

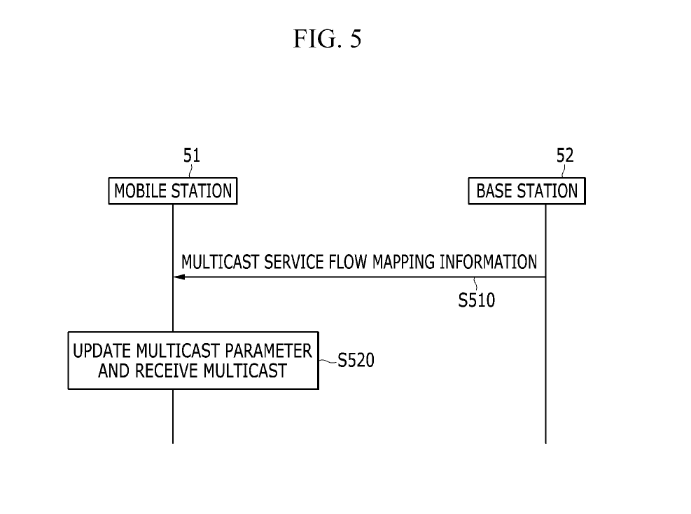

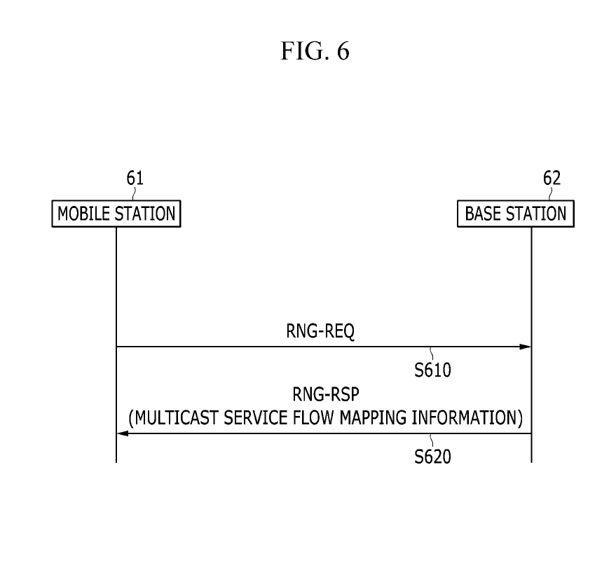

As described above, if a target cell belongs to the same multicast group zone when a mobile station crosses the boundary of a cell, the mobile station can seamlessly receive a multicast service regardless of the state of the mobile station. On the other hand, the mobile station may cross the boundary of a multicast group zone and move to a cell that belongs to a multicast group zone which is different from a serving multicast group zone. Hereinafter, a multicast service managing method for supporting the mobility when the mobile station crosses the boundary of the multicast group zone will be described with reference to FIG. 5 and FIG. 6.

FIG. 5 and FIG. 6 each are a flowchart showing a multicast service managing method according to an embodiment of the present invention.

Referring to FIG. 5, a base station 52 periodically broadcasts a broadcast message including multicast service flow mapping information of a current multicast group zone and a neighbor multicast group zone, for supporting the mobility (S510). A neighbor advertisement (NBR-ADV) message may be used as the broadcast message.

In one embodiment, as shown in Table 1, the multicast service flow mapping information of the NBR-ADV message includes a neighbor multicast group zone ID representing a multicast group zone of a neighbor base station (i.e., a new multicast group zone) and a list of multicast group ID2 mappings. The multicast service flow mapping information may further include a multicast group zone ID representing a multicast group zone of a current base station. The list of multicast group ID2 mappings includes multicast group ID2s of multicast group zones, that is, current multicast group ID2s [Current_MGID(1), . . . , Current_MGID(N)] and multicast group ID2s of neighbor multicast group zones mapped to them, i.e., new multicast group ID2s [New_MGID(1), . . . , New_MGID(N)]. If a service flow corresponding to the current multicast group ID2 cannot be used in the neighbor multicast group zone, the new multicast group ID2 may have a predetermined value.

TABLE 1

| | Length | |
|---|---|---|
| Field | (bits) | Notes |
| Multicast Group Zone ID | 12 | Multicast group zone |
| | | ID for current |
| | | multicast group zone |
| Neighbor Multicast Group | 12 | Multicast group zone |
| Zone ID | | ID for neighbor |
| | | multicast group zone |
| List of Multicast Group ID | variable | Current_MGID(1), |
| Mappings | N × 4 | New_MGID(1), . . . , |
| | | Current_MGID(N), |
| | | New_MGID(N) |

In another embodiment, as shown in Table 2, the multicast service flow mapping information of the NBR-ADV message includes a neighbor multicast group zone ID and a list of multicast group ID1 and FID mappings. The list of multicast group ID1 and FID mappings includes multicast group ID1s and FIDs of a current multicast group zone and multicast group ID1s and FIDs of a neighbor multicast group zone (i.e., a new multicast group zone) that are mapped to them.

TABLE 2

| | | Length | |
|---|---|---|---|
| Field | | (bits) | Notes |
| Neighbor Multicast | | 12 | Multicast group zone ID provided by neighbor base station |
| Group Zone ID | | | |
| For (j=1; j<=M; j++){ | | | M: Number of multicast group ID and FID mappings |
| | | between serving base station and neighbor base station | |
| | Multicast Group ID | 12 | Multicast group ID provided by base station belonging to |
| | | | current multicast group zone |
| | FID | 4 | FID provided by base station belonging to current multicast |
| | | | group zone |
| | Neighbor Multicast | 12 | Multicast group ID provided by base station belonging to |
| Group ID | | | neighbor multicast group zone |
| | Neighbor FID | 4 | FID provided by base station belonging to neighbor |

| | |
|---|---|
| | multicast group zone |
| } | |

Further, a multicast group zone ID to which a current base station of a mobile station belongs may be transmitted through other broadcast message, for example, a system configuration descriptor (SCD) message or a downlink channel descriptor (DCD) message. If a neighbor base station does not support a multicast service, the multicast group zone ID of the SCD message or DCD message may be set to “0” such that no support of the multicast service can be notified. To minimize the overhead of the message, only base station located at the boundary of the multicast group zone may include the multicast group zone ID to the broadcast message.

When the mobile station 51 crosses the boundary of the multicast group zone and moves to the neighbor multicast group zone, the mobile station 51 updates the multicast parameter associated with multicast service flow based on the received broadcast message and continuously receives the multicast service (S520).

According to another embodiment of the present invention, when a mobile station of a connected state crosses the boundary of a multicast group zone, the mobile station may perform a ranging procedure with a base station of a target cell and update a multicast parameter associated with a multicast service flow during the ranging procedure. The connected state may be an active state or sleep state where a connection is maintained. As shown in FIG. 6, a mobile station 61 transmits a ranging request (RNG-REQ) message to a target base station 62 (S610), and the target base station 62 transmits a ranging response (RNG-RSP) message to the mobile station 61 in response to the RNG-REQ message (S620).

In this case, a ranging purpose indication of the RNG-REQ message may be set to a value representing a multicast service flow update.

In one embodiment, the RNG-RSP message may include multicast service flow mapping information shown in Table 1. In this case, a neighbor multicast group zone ID indicates a multicast group zone ID to which a base station belongs before performing a handover, a multicast group zone ID indicates a multicast group zone ID to which a target base station belongs, and a new multicast group ID2 indicates a multicast group ID2 that is used in a multicast group zone to which the target base station belongs. In another embodiment, the RNG-RSP message may include multicast service flow mapping information shown in Table 3. That is, the multicast service flow mapping information includes a new multicast group zone ID and a list of multicast group ID1 and FID mappings. The list of multicast group ID1 and FID mappings includes multicast group ID1 s and FIDs of a current multicast group zone, and multicast group ID1s and FIDs of a new multicast group zone that are mapped to them.

TABLE 3

| | | Length | |
|---|---|---|---|
| Field | | (bits) | Notes |
| New Multicast | | 12 | Multicast group zone ID to update |
| Group Zone ID | | | as multicast group zone ID provided |
| | | by current base station | |
| For (j=1; j<=M; | | | M: Number of multicast group ID and |
| j++){ | | | FID mappings to update |
| | Current Multicast | 12 | Multicast group ID stored in |
| Group ID | | | mobile station |
| | Current FID | 4 | FID stored in mobile station |
| | New Multicast | 12 | Multicast group ID to update in |
| Group ID | | | mobile station |
| | New FID | 4 | FID to update in mobile station |

}

Further, a multicast group zone ID to which a current base station of a mobile station belongs may be transmitted through other broadcast message, for example, an SCD message or a DCD message.

Accordingly, the mobile station updates the multicast parameter associated with the multicast service flow based on the RNG-RSP message, and continuously receives the multicast service.

On the other hand, when a mobile station of a connected state crosses the boundary of a multicast group zone, a handover message received by the mobile station may include multicast service flow update information shown in Table 1 or 3.

Accordingly to yet another embodiment of the present invention, when a mobile station of an idle state crosses the boundary of a multicast group zone, the mobile station may perform a location update procedure in a base station of a target cell, and update a multicast parameter associated with a multicast service flow during the location update procedure. For the location update, the mobile station and the base station exchange an RNG-REQ message and an RNG-RSP message as shown in FIG. 6. In this case, a ranging purpose indication of the RNG-REQ message may be set to a value representing a multicast service flow update. The RNG-RSP message may include multicast service flow mapping information shown in Table 1 or 3.

Further, a multicast group zone ID to which a current base station of a mobile station belongs may be transmitted through other broadcast message, for example, a paging advertisement (PAG-ADV) message.

As described above, according to embodiments of the present invention, a new multicast group zone ID, current multicast service identification information (i.e., a multicast group ID2 or a multicast group ID1 and FID), and new multicast service identification information mapped to this can be provided. Accordingly, a mobile station can quickly update a multicast parameter associated with a multicast service flow when crossing the boundary of a multicast group zone.

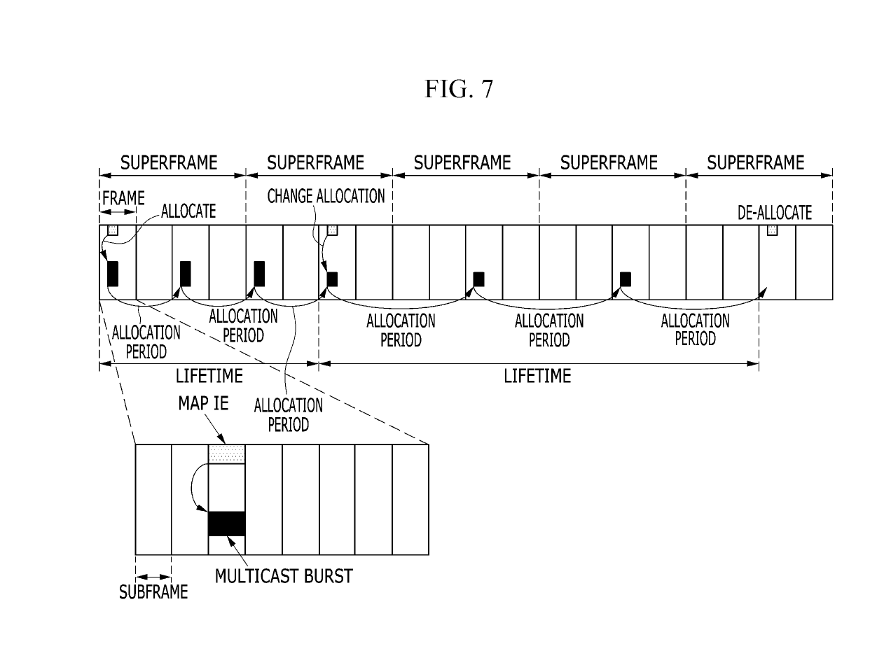

Next, a downlink control channel including allocation information of a multicast resource will be described with reference to FIG. 7.

FIG. 7 shows an allocation method of a multicast resource according to an embodiment of the present invention.

A base station persistently allocates a multicast resource to a multicast group for a multicast communication, and a downlink control channel including allocation information of the multicast resource. The downlink control channel may be a MAP information element (IE).

For the multicast resource allocation, a new MAP IE may be defined. For example, the new MAP IE may be an HR-Multicast DL MAP IE (high reliability multicast downlink MAP IE) or an HR Multicast DL Assignment A-MAP IE that is a new type of A-MAP (advanced MAP).

As shown in FIG. 7, the base station periodically (i.e., persistently) allocates the multicast resource at an interval of predetermined frames. The interval of predetermined frames corresponds to an allocation period. A plurality of frames, for example four frames may form one superframe, and one frame may include a plurality of subframes, for example eight subframes. In this case, the base station may transmit the MAP IE at a subframe to which the multicast resource is allocated.

The MAP IE includes multicast resource information allocated for the multicast communication, the allocation period, and a lifetime. The lifetime indicates a period in which a persistent allocation is maintained, and the resource allocation information does not change until the lifetime expires. If the lifetime expires, the base station allocates a persistent resource for the multicast communication again or releases the previously allocated resource, and transmits the MAP IE including relevant information. The base station may transmit a next MAP IE at a frame whose frame number N_{frame} satisfies Equation 1, or may transmit the next MAP IE at a superframe whose superframe number N_{superframe} satisfies Equation 2.

N_{frame} modulo L+1=0 (1)

N_{superframe} modulo L+1=0 (2)

In Equations 1 and 2, L indicates the lifetime.

Since the terminal can acquire information on the persistently allocated resource by only one decoding on the MAP IE, a power loss that occurs when decoding the MAP IE can be reduced. Further, the terminal can know a period in which the MAP IE is transmitted or a period in which a multicast burst is transmitted in advance such that the terminal can efficiently perform a power saving when entering a power saving mode such as a sleep mode or an idle mode. Furthermore, since the terminal can know a time for decoding a new MAP IE by the lifetime included in the current MAP IE, the terminal can check a change of the persistently allocated resource.

The MAP IE may further include information on a multicast connection, for example a multicast group ID2 such that the mobile station can identify the MAP IE. Alternatively, the base station may generate 16-bit cyclic redundancy check (CRC) based on the randomized sequence of information bits of the MAP IE. Further, the base station may mask the 16-bit CRC by a CRC mask including a multicast group ID1, and attach the masked CRC to the MAP IE. The mobile station can identify the MAP IE using the CRC mask including the multicast group ID1 to which it belongs.

An example of FIG. 7 shows that the multicast resource is persistently allocated with the allocation period of 2 and the lifetime of 6, the multicast resource is persistently allocated with the allocation period of 4 and the lifetime of 12, and then the allocated resource is released.

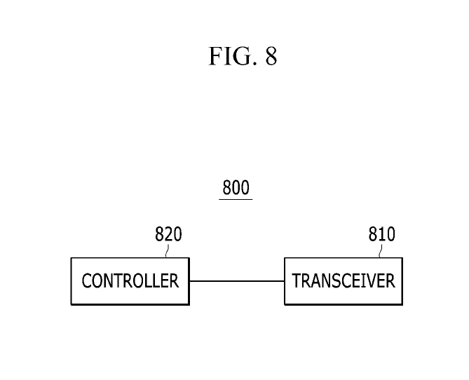

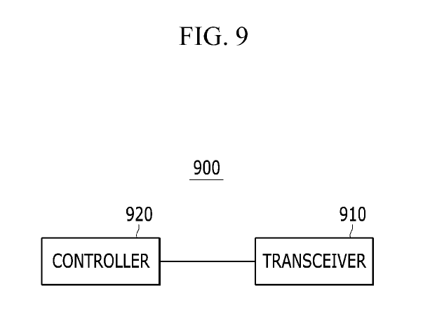

Next, a multicast service managing apparatus for performing a multicast service managing method according to an embodiment of the present invention will be described with reference to FIG. 8 and FIG. 9.

FIG. 8 and FIG. 9 each are a block diagram of a multicast service managing apparatus according to an embodiment of the present invention.

Referring to FIG. 8, a multicast service managing apparatus 800 includes a transceiver 810 and a controller 820. The multicast service managing apparatus 800 of FIG. 8 may be included in a mobile station or may be the mobile station.

The transceiver 810 receives a message including multicast service flow update information, for example, an NBR-ADV message or an RNG-RSP message from a base station. The multicast service flow update information may include information shown in Table 1, 2 or 3, as described above. The transceiver 810 may receive a broadcast message including a multicast group zone ID from the base station. The transceiver 810 may transmit the RNG-REQ message to the base station when the mobile station crosses the boundary of the multicast group zone.

The controller 820 updates a parameter associated with a multicast service flow based on the multicast service flow update information when the mobile station crosses the boundary of the multicast group zone.

Referring to FIG. 9, a multicast service managing apparatus 900 includes a transceiver 910 and a controller 920. The multicast service managing apparatus 900 of FIG. 9 may be included in a base station or may be the base station.

The transceiver 910 transmits a message including multicast service flow update information, for example, an NBR-ADV message or an RNG-RSP message to a mobile station. The multicast service flow update information may include information shown in Table 1, 2 or 3, as described above. The transceiver 910 may transmit a broadcast message including a multicast group zone ID to the mobile station. The transceiver 910 may receive the RNG-REQ message from the mobile station when the mobile station crosses the boundary of the multicast group zone.

The controller 920 generates the multicast service flow update information based on information on a multicast group zone of a neighbor base station, and provides the transceiver 910 with the multicast service flow update information.

As described above, according to embodiments of the present invention, a new multicast group zone ID, current multicast service identification information, and new multicast service identification information mapped to this can be provided. Accordingly, a mobile station can quickly update a multicast parameter associated with a multicast service flow when crossing the boundary of a multicast group zone.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of managing a multicast service by a mobile station, the method comprising:
receiving the multicast service;
receiving a message including multicast service flow update information from a base station that belongs to a multicast group zone including a base station set having at least one base station; and
updating a parameter associated with a multicast service flow of the multicast service based on the multicast service flow update information,
wherein the multicast service flow update information includes a new multicast group zone identifier (ID), current multicast service identification information, and new multicast service identification information mapped to the current multicast service identification information.

2. The method of claim 1, wherein the current multicast service identification information includes a multicast group ID that is used for identifying the multicast service flow in a current multicast group zone, and
the new multicast service identification information includes a multicast group ID that is used for identifying the multicast service flow in a new multicast group zone.

3. The method of claim 1, wherein the current multicast service identification information includes a multicast group ID and a flow ID (FID) that are used for identifying the multicast service flow in a current multicast group zone, and
the new multicast service identification information includes a multicast group ID and an FID that are used for identifying the multicast service flow in a new multicast group zone.

4. The method of claim 1, wherein the message includes a neighbor advertisement (NBR-ADV) message that is periodically broadcast by the base station.

5. The method of claim 1, further comprising transmitting a ranging request (RNG-REQ) message to a base station, in a connected state, and
the message includes a ranging response (RNG-RSP) message that is transmitted in response to the RNG-REQ message.

6. The method of claim 1, further comprising transmitting an RNG-REQ message to the base station, in an idle state, and
the message includes an RNG-RSP message that is transmitted in response to the RNG-REQ message.

7. The method of claim 1, further comprising receiving a broadcast message including a multicast group zone ID to which the base station belongs.

8. A method of managing a multicast service by a base station that belongs to a multicast group zone including a base station set having at least one base station, the method comprising
generating multicast service flow update information for a multicast service flow of the multicast service provided to a mobile station; and
transmitting a message including the multicast service flow update information to the mobile station,
wherein the multicast service flow update information includes a new multicast group zone identifier (ID), current multicast service identification information, and new multicast service identification information.

9. The method of claim 8, wherein the current multicast service identification information includes a multicast group ID that is used for identifying the multicast service flow in a current multicast group zone, and
the new multicast service identification information includes a multicast group ID that is used for identifying the multicast service flow in a new multicast group zone.

10. The method of claim 8, wherein the current multicast service identification information includes a multicast group ID and a flow ID (FID) that are used for identifying the multicast service flow in a current multicast group zone, and
the new multicast service identification information includes a multicast group ID and an FID that are used for identifying the multicast service flow in a new multicast group zone.

11. The method of claim 8, wherein the message includes a neighbor advertisement (NBR-ADV) message that is periodically broadcast by the base station.

12. The method of claim 8, further comprising receiving a ranging request (RNG-REQ) message from the mobile station when the mobile station is in a connected state, and
the message includes a ranging response (RNG-RSP) message that is transmitted in response to the RNG-REQ message.

13. The method of claim 8, further comprising receiving an RNG-REQ message from the mobile station when the mobile station is in an idle state, and
the message includes an RNG-RSP message that is transmitted in response to the RNG-REQ message.

14. The method of claim 8, further comprising receiving a broadcast message including a multicast group zone ID to which the base station belongs.

15. An apparatus for managing a multicast service, the apparatus comprising:
a transceiver configured to receive the multicast service, and to receive a message including multicast service flow update information from a base station that belongs to a multicast group zone including a base station set having at least one base station; and
a controller configured to update a parameter associated with a multicast service flow of the multicast service based on the multicast service flow update information,
wherein the multicast service flow update information includes a new multicast group zone identifier (ID), current multicast service identification information, and new multicast service identification information mapped to the current multicast service identification information.

16. The apparatus of claim 15, wherein the current multicast service identification information includes a multicast group ID that is used for identifying the multicast service flow in a current multicast group zone, and
the new multicast service identification information includes a multicast group ID that is used for identifying the multicast service flow in a new multicast group zone.

17. The apparatus of claim 15, wherein the current multicast service identification information includes a multicast group ID and a flow ID (FID) that are used for identifying the multicast service flow in a current multicast group zone, and
the new multicast service identification information includes a multicast group ID and an FID that are used for identifying the multicast service flow in a new multicast group zone.

18. An apparatus for managing a multicast service by a base station that belongs to a multicast group zone including a base station set having at least one base station, the apparatus comprising:
a controller configured to generate multicast service flow update information for a multicast service flow of the multicast service provided to a mobile station; and
a transceiver configured to transmit a message including the multicast service flow update information to the mobile station,
wherein the multicast service flow update information includes a new multicast group zone identifier (ID), current multicast service identification information, and new multicast service identification information.

19. The apparatus of claim 18, wherein the current multicast service identification information includes a multicast group ID that is used for identifying the multicast service flow in a current multicast group zone, and
the new multicast service identification information includes a multicast group ID that is used for identifying the multicast service flow in a new multicast group zone.

20. The apparatus of claim 18, wherein the current multicast service identification information includes a multicast group ID and a flow ID (FID) that are used for identifying the multicast service flow in a current multicast group zone, and
the new multicast service identification information includes a multicast group ID and an FID that are used for identifying the multicast service flow in a new multicast group zone.
